(19) United States
(12) Patent Application Publication
(10) Pub. No.: US 2019/0033999 A1
(43) Pub. Date: Jan. 31, 2019

(54) NON-CONTACT INPUT DEVICE, NON-CONTACT INPUT METHOD, AND DISPLAY DEVICE CAPABLE OF BEING CONTROLLED BY NON-CONTACT INPUT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); YU-YONG ZHANG, Shenzhen (CN)

(21) Appl. No.: 15/722,025

(22) Filed: Oct. 2, 2017

(30) Foreign Application Priority Data
Jul. 26, 2017 (CN) 201710619146.8

(51) Int. Cl. G06F 3/044; G06F 3/041; G06F 3/045; G02F 1/1333

(52) U.S. Cl. CPC G06F 3/044; G02F 1/13338; G06F 3/045; G06F 3/0412

(57) ABSTRACT

A non-contact input method is applied in a device capable of communicating with a transparent touch device held by a user and a display screen. The method includes steps of obtaining a position of user's eyes, a first distance between the user's eyes and the touch device, a second distance between the touch device and the display screen, and a type of touch operation such as click or doubleclick. A touch position on the touch device is obtained and a corresponding input position on the display screen is determined accordingly. A touch command corresponding to the obtained type of the touch operation is recognized and acted upon by the display screen.

### FIELD

The subject matter relates to input devices, and more particularly, to a non-contact input device, a non-contact input method, and a display device capable of being controlled by non-contact input.

### BACKGROUND

On many occasions, large display screens are needed that can show files to users. However, the users may be spaced from the display screen and cannot directly touch the display screen. Thus, the users cannot perform touch operations on the display screen and control the display screen to perform corresponding function. Improvements in the art are preferred.

### BRIEF DESCRIPTION OF THE DRAWINGS

Implementations of the present technology will now be described, by way of example only, with reference to the attached figures.

FIG. 1 is a block diagram of an exemplary embodiment of a non-contact input system including a display screen, a non-contact input device, and a touch device.

FIG. 2 is a block diagram of the non-contact input device of FIG. 1.

FIG. 3 is a flowchart of an exemplary embodiment of a non-contact input method.

FIG. 4 is a diagram showing principles for determining a coordinate of a touch position in a three-dimensional (3D) coordinate system.

FIG. 5 is a diagram showing principles for determining a coordinate of an input position in the 3D coordinate system.

FIG. 6 is a block diagram of another exemplary embodiment of a non-contact input system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

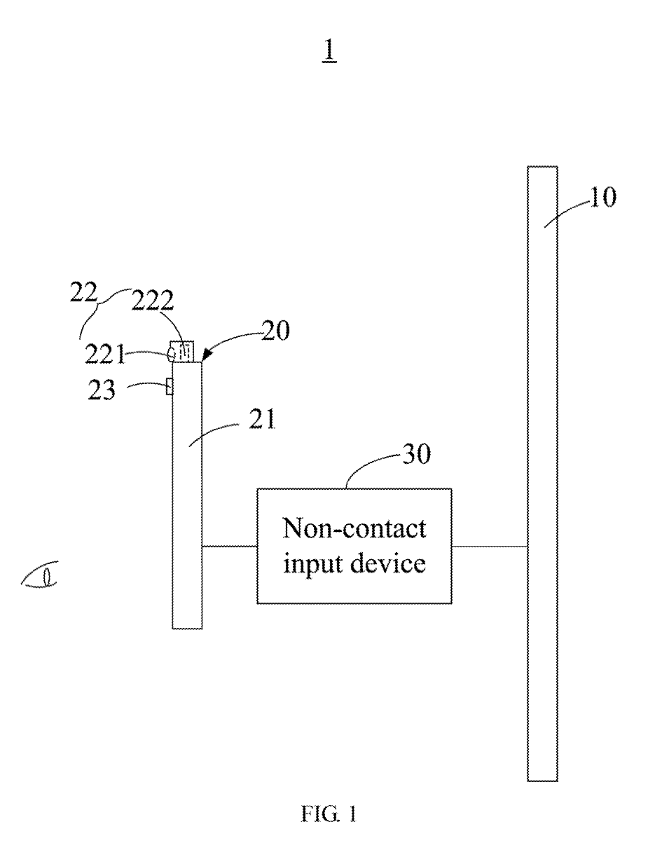

FIG. 1 illustrates an exemplary embodiment of a non-contact input system 1 comprising a display screen 10, a transparent touch device 20, and a non-contact input device 30 connected to the display screen 10 and the touch device 20. The device 30 can communicate with the display screen 10 and the touch device 20 through a wired or a wireless manner.

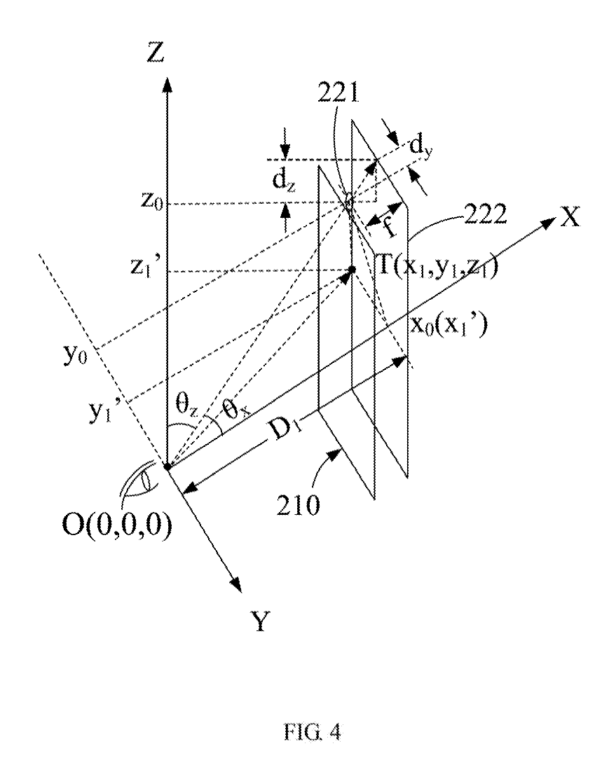

The touch device 20 comprises a transparent touch panel 21, an eye tracker 22, and a distance sensor 23. The eye tracker 22 and the distance sensor 23 are mounted on the touch panel 21. The touch panel 21 comprises an operation surface 210 (shown in FIG. 4) for a user to perform a physical touch operation.

When the user wants to control the display screen 10 to perform a function at a certain input position on the display screen 10, the user can stare at the certain input position and place the touch device 20 in front of the user's eyes. That is, the user can stare at the certain input position through the touch device 20. Then, the user can perform a touch operation at a corresponding touch position on the operation surface 210. The touch position is an intersection point of the touch panel 21 and an imaginary line connecting the user's eyes and the input position. That is, the input position is an intersection point of the display screen 10 and a line extending from an imaginary line connecting the user's eyes and the touch position. The touch operation can be a clicking operation, a double-clicking operation, a sliding operation, a zoom-in operation, a zoom-out operation, or a character input operation.

When the user performs the touch operation on the touch panel 21, the touch panel 21 determines a type of the touch operation and the touch position of the touch operation on the touch panel 21.

When the user performs the touch operation on the touch panel 21, the eye tracker 22 detects the position of the user's eyes (hereinafter, “eye position”). The eye tracker 22 can be a camera. The camera can capture an image of the user, identify the user's face in the captured image, and identify the eye position in the identified user's face. In at least one exemplary embodiment, the camera further comprises a lens 221, an image sensor 222 positioned at an imaging plane of the lens 221, and an image processor (not shown) electrically connected to the image sensor 222. When the user is in front of the camera, the light reflected from the user can travel through the lens 221 and focus on the image sensor 222. Thus, the image is formed on the image sensor 222. The image processor obtains the image from the image sensor 222, identifies the user's face in the obtained image, and identifies the eye position in the identified user's face. The center of the lens 221 is substantially located on the operation surface 210, that is, the center of the lens 221 is substantially coplanar with the operation surface 210.

The distance sensor 23 detects a first distance between the user's eyes and the touch panel 21 (that is, a distance between the user and the touch panel 21), and detects a second distance between the display screen 10 and the touch panel 21. In at least one exemplary embodiment, the distance sensor 23 can be an infrared sensor.

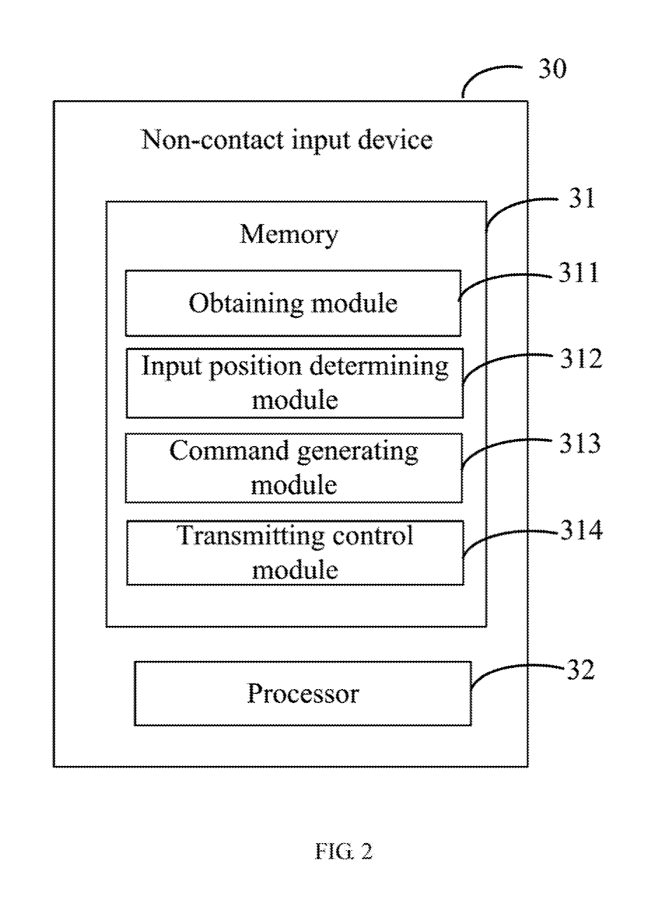

Referring to FIG. 2, the device 30 comprises a memory 31 and at least one processor 32. The memory 31 stores an obtaining module 311, an input position determining module 312, a command generating module 313, and a transmitting control module 314. The modules 311-314 may comprise computerized instructions in the form of one or more programs that are executed by the at least one processor 32.

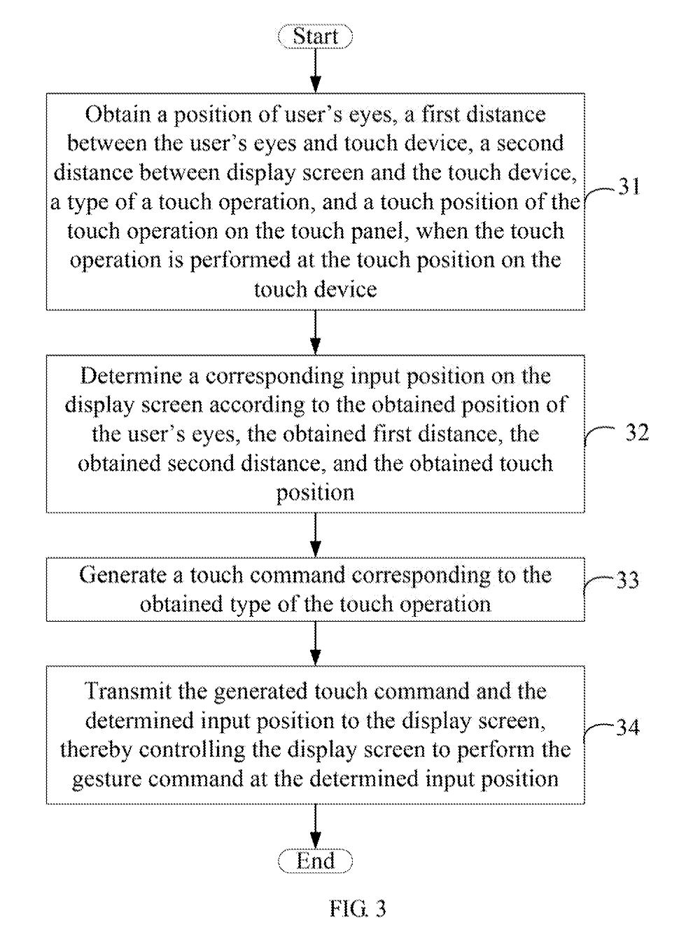

FIG. 3 illustrates an exemplary embodiment of a non-contact input method. The method is provided by way of example, as there are a variety of ways to carry out the method. The method described below can be carried out using the configurations illustrated in FIGS. 1-2, for example, and various elements of these figures are referenced in explaining example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 31.

At block 31, the obtaining module 311 obtains the eye position, the first distance, the second distance, the type of the touch operation, and the touch position of the touch operation on the touch panel 21.

At block 32, the input position determining module 312 determines a corresponding input position on the display screen 10 according to the obtained eye position, the obtained first distance, the obtained second distance, and the obtained touch position. In at least one exemplary embodiment, the input position determining module 312 establishes a three-dimensional (3D) coordinate system X-Y-Z by setting the eye position as an origin, determines a coordinate of the touch position in the 3D coordinate system X-Y-Z, and determines a coordinate of the input position in the 3D coordinate system X-Y-Z according to the obtained first distance, the obtained second distance, and the determined coordinate of the touch position.

Referring to FIG. 4, the X-axis of the 3D coordinate system X-Y-Z being perpendicular to the display screen 10 is taken as an example. That is, the X-axis is parallel to the ground surface. However, in other exemplary embodiments, the direction of the X-axis can be varied as needed. The coordinate of the eye position O is defined as (0, 0, 0). The coordinate of the lens 221 of the eye tracker 22 in the 3D coordinate system X-Y-Z is defined as (x₀, y₀, z₀). The first distance is defined as D₁. Then, the coordinate (x₀, y₀, z₀) of the lens 221 can be calculated as follows:

$${x}_{0} = {D}_{1}$$

$${y}_{0} = {x}_{0} \times tan {θ}_{x} = {D}_{1} \times \frac{{d}_{y}}{f}$$

$${z}_{0} = \sqrt{{x}_{0}^{2} + {y}_{0}^{2} - {z}_{0}^{2}} \times tan {θ}_{z} = \sqrt{{x}_{0}^{2} + {y}_{0}^{2} - {z}_{0}^{2}} \times \frac{{d}_{z}}{f} = {D}_{1} \times \frac{{d}_{z}}{f} \times \sqrt{\frac{{f}^{2} + {d}_{y}^{2}}{{f}^{2} + {d}_{z}^{2}}}$$

Wherein d_{y} represents a Y-axis component of a distance between the user's eyes in the image formed in the image sensor 222 and a center of the image. d_{y} represents a Z-axis component of the distance between the user's eyes in the image formed in the image sensor 222 and the center of the image. f represents a focal length of the lens 221 (usually set by the manufacturer). θₓ represents an angle between X-axis and an imaginary line connecting the user's eyes and the lens 221, and θ_{z} represents an angle between Z-axis and an imaginary line connecting the user's eyes and the lens 221.

Furthermore, the coordinate of the touch position T on the operation surface 210 is defined as (x₁, y₁, z₁) with respect to the lens 221. The coordinate of the touch position T in the 3D coordinate system X-Y-Z is defined as (x₁′, y₁′, z₁′). Then the coordinate (x₁′, y₁′, z₁′) of the touch position T can be calculated as follows:

$${x}_{1}^{′} = {x}_{0} = {D}_{1}$$

$${y}_{1}^{′} = {y}_{0} - {y}_{1} = {D}_{1} \times \frac{d}{f} - {y}_{1}$$

$${z}_{1}^{′} = {z}_{0} - {z}_{1} = {D}_{1} \times \frac{{d}_{z}}{f} \times \sqrt{\frac{{f}^{2} + {d}_{y}^{2}}{{f}^{2} + {d}_{z}^{2}}} - {z}_{1}$$

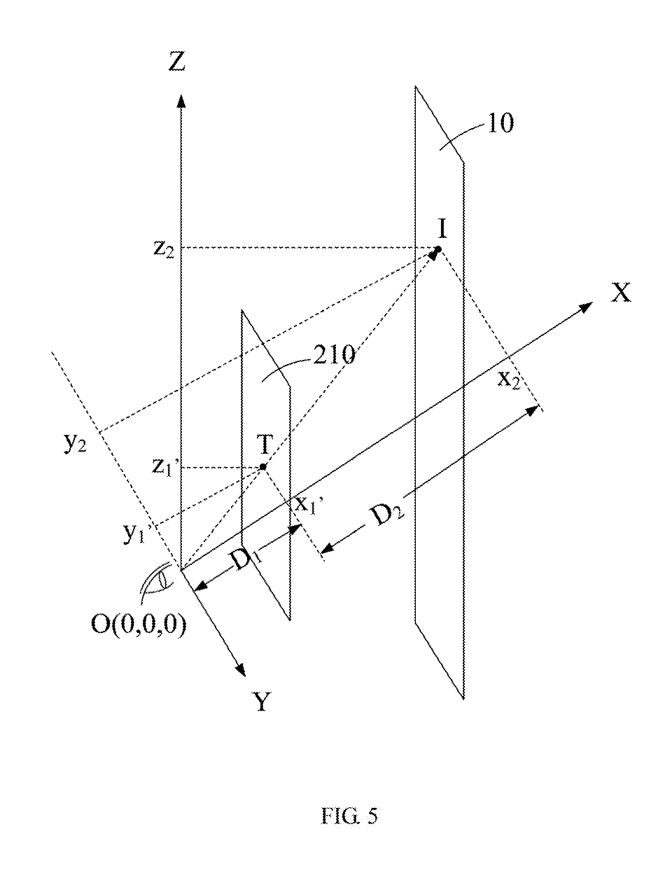

Referring to FIG. 5, the second distance is defined as D₂. The coordinate of the input position I in the 3D coordinate system X-Y-Z is defined as (x₂, y₂, z₂). Then, the coordinate (x₂, y₂ z₂) of the input position I can be calculated as follows:

$${x}_{2} = \frac{{D}_{1} + {D}_{2}}{{D}_{1}} \times {x}_{1}^{′} = {D}_{1} + {D}_{2}$$

$${y}_{2} = \frac{\overline{OI}}{\overline{OT}} \times {y}_{1}^{′} = \frac{{x}_{2}}{{x}_{1}} \times {y}_{1}^{′} = \frac{{D}_{1} + {D}_{2}}{{D}_{1}} \times ( {D}_{1} \times \frac{d}{f} - {y}_{1} )$$

$${z}_{2} = \frac{\overline{OI}}{\overline{OT}} \times {z}_{1}^{′} = \frac{{x}_{2}}{{x}_{1}} \times {z}_{1}^{′} = \frac{{D}_{1} + {D}_{2}}{{D}_{1}} \times ( {D}_{1} \times \frac{d}{f} \times \sqrt{\frac{{f}^{2} + {d}_{y}^{2}}{{f}^{2} + {d}_{z}^{2}}} - {z}_{1} )$$

In other exemplary embodiment, the input position determining module 312 can also establish the 3D coordinate system X-Y-Z by setting the position of the eye tracker 22 as the origin. In this case, the calculation of the coordinate of the touch position and the coordinate of the input position is similar to the calculation described above.

At block 33, the command generating module 313 generates a touch command corresponding to the obtained type of the touch operation.

At block 34, the transmitting control module 314 transmits the generated touch command and the determined input position to the display screen 10, thereby controlling the display screen 10 to perform the touch operation at the determined input position. In at least one exemplary embodiment, the transmitting control module 314 can transmit the generated touch command and the determined input position to the display screen 10 in a wireless manner (for example, BLUETOOTH or WI-FI).

For example, when the user wants to double-click an icon on the display screen 10 and run a corresponding application program, the user can first find the icon on the display screen 10 by staring through the touch panel 21, and double-click a corresponding touch position on the touch panel 21 along the user's sight. The touch input position is an intersection point of the touch panel 21 and an imaginary line connecting the user's eyes and the icon. Then, the device 30 can control the display screen 10 to run a corresponding application program of the icon.

With the above configuration, the user can first find the desired input position on the display screen 10 through the touch panel 20, and perform a touch operation at the corresponding touch position on the touch panel 21 along the user's sight. The device 30 can synchronize the touch operation to the input position on the display screen 10 and control the display screen 10 to perform the touch operation at the input position.

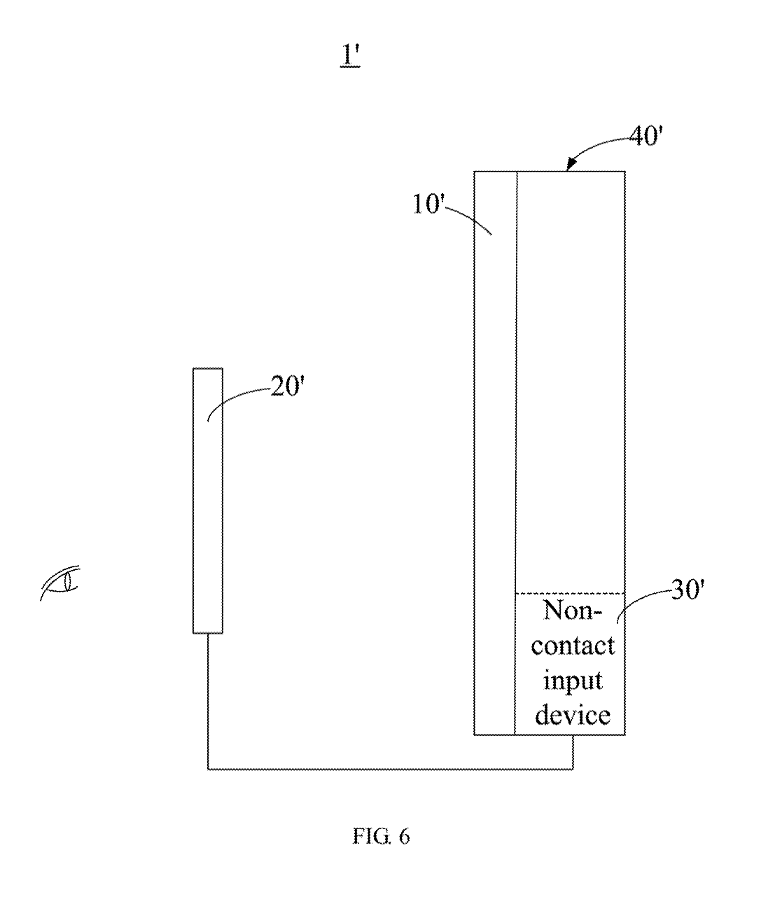

FIG. 6 illustrates a non-contact input system 1′ in another exemplary embodiment. Different from the above system 1, the system 1′ comprises a display device 40′ capable of being controlled by non-contact input and a transparent touch device 20′. The display device 40′ comprises a display screen 10′ and a non-contact input device 30′. That is, the display screen 10′ and the device 30′ are both components of the display device 40′. The function of the device 30′ is similar to the function of the device 30 described above.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

1. A non-contact input device capable of communicating with a transparent touch device and a display screen, the non-contact input device comprising:
at least one processor; and
a memory coupled to the at least one processor and storing one or more programs, wherein when executed by the at least one processor, the one or more programs causing the at least one processor to:
obtain, from the touch panel, a position of user's eyes, a first distance between the user's eyes and the touch device, a second distance between the display screen and the touch device, a type of a touch operation, and a touch position of the touch operation on the touch panel, when the touch operation is performed at the touch position on the touch device, wherein the touch operation is one of a sliding operation, a zoom-in operation, a zoom-out operation, and a character input operation;
determine a corresponding input position on the display screen according to the obtained position of the user's eyes, the obtained first distance, the obtained second distance, and the obtained touch position, the input position being an intersection point of the display screen and a line extending from an imaginary line connecting the user's eyes and the touch position;
generate a touch command corresponding to the obtained type of the touch operation; and
transmit the generated touch command and the determined input position to the display screen, thereby controlling the display screen to perform the touch operation at the determined input position.

2. The non-contact input device of claim 1, wherein to determine the corresponding input position, the one or more programs causes the at least one processor to:
establish a three-dimensional (3D) coordinate system by setting the position of the user's eyes as an origin;
determine a coordinate of the touch position in the 3D coordinate system; and
determine a coordinate of the input position in the 3D coordinate system according to the obtained first distance, the obtained second distance, and the determined coordinate of the touch position.

3. The non-contact input device of claim 1, wherein the generated touch command and the determined input position are transmitted to the display screen through a wireless manner.

4. (canceled)

5. A non-contact input method applied in a non-contact input device that is capable of communicating with a transparent touch device and a display screen, the non-contact input method comprising:
obtaining, from the touch panel, a position of user's eyes, a first distance between the user's eyes and the touch device, a second distance between the display screen and the touch device, a type of a touch operation, and a touch position of the touch operation on the touch panel, when the touch operation is performed at the touch position on the touch device, wherein the touch operation is one of a sliding operation, a zoom-in operation, a zoom-out operation, and a character input operation;
determining a corresponding input position on the display screen according to the obtained position of the user's eyes, the obtained first distance, the obtained second distance, and the obtained touch position, the input position being an intersection point of the display screen and an extending line from an imaginary line connecting the user's eyes and the touch position;
generating a touch command corresponding to the obtained type of the touch operation; and
transmitting the generated touch command and the determined input position to the display screen, thereby controlling the display screen to perform the touch operation at the determined input position.

6. The non-contact input method of claim 5, wherein the “determining a corresponding input position on the display screen according to the obtained position of the user's eyes, the obtained first distance, the obtained second distance, and the obtained touch position” further comprises:
establishing a three-dimensional (3D) coordinate system by setting the position of the user's eyes as an origin;
determining a coordinate of the touch position in the 3D coordinate system; and
determining a coordinate of the input position in the 3D coordinate system according to the obtained first distance, the obtained second distance, and the determined coordinate of the touch position.

7. The non-contact input method of claim 5, wherein the generated touch command and the determined input position are transmitted to the display screen through a wireless manner.

8. (canceled)

9. A display device capable of being controlled by non-contact input, the display device comprising a display screen and a non-contact input device capable of communicating with the display screen, the non-contact input device further capable of communicating with a transparent touch device, the non-contact input device comprising:
at least one processor; and
a memory coupled to the at least one processor and storing one or more programs, wherein when executed by the at least one processor, the one or more programs causing the at least one processor to:
obtain, from the touch panel, a position of user's eyes, a first distance between the user's eyes and the touch device, a second distance between the display screen and the touch device, a type of a touch operation, and a touch position of the touch operation on the touch panel, when the touch operation is performed at the touch position on the touch device, wherein the touch operation is one of a sliding operation, a zoom-in operation, a zoom-out operation, and a character input operation;
determine a corresponding input position on the display screen according to the obtained position of the user's eyes, the obtained first distance, the obtained second distance, and the obtained touch position, the input position being an intersection point of the display screen and a line extending from an imaginary line connecting the user's eyes and the touch position;
generate a touch command corresponding to the obtained type of the touch operation; and
transmit the generated touch command and the determined input position to the display screen, thereby controlling the display screen to perform the touch operation at the determined input position.

10. The display device of claim 9, wherein to determine the corresponding input position, the one or more programs causes the at least one processor to:
establish a three-dimensional (3D) coordinate system by setting the position of the user's eyes as an origin;
determine a coordinate of the touch position in the 3D coordinate system; and
determine a coordinate of the input position in the 3D coordinate system according to the obtained first distance, the obtained second distance, and the determined coordinate of the touch position.

11. The display device of claim 9, wherein the generated touch command and the determined input position are transmitted to the display screen through a wireless manner.

12. (canceled)
